(19) United States
(12) Patent Application Publication
(10) Pub. No.: US 2007/0070983 A1
(43) Pub. Date: Mar. 29, 2007

(54) Methods and apparatus for improved efficiency communication

(75) Inventors: Jason Keith Redi, Belmont, MA (US); Regina Rosales Hain, Winchester, MA (US); Subramanian Ramanathan, Westford, MA (US)

Correspondence Address: FISH & NEAVE IP GROUP;ROPES & GRAY LLP, ONE INTERNATIONAL PLACE, BOSTON, MA, 02110-2624, US

(73) Assignee: BBN Technologies Corp., Cambridge, MA (US)

(21) Appl. No.: 11/347,963

(22) Filed: Feb. 6, 2006

Related U.S. Application Data
(60) Provisional application No. 60/721,960, filed on Sep. 28, 2005.

(51) Int. Cl. H04L 12/66

(52) U.S. Cl. 370/352; 370/401

(57) ABSTRACT

The invention relates to methods, apparatus, and software for disseminating link state information in an ad hoc network. The methods, apparatus, and software include an energy conserving processing based on a combination of a multipoint relaying and hazy scoping.

### CROSS REFERENCE TO RELATED APPLICATIONS

This application claims priority under 35 U.S.C. § 119(e) to U.S. Provisional Application No. 60/721,960, titled “Methods and Apparatus for Improved Efficiency Communication,” filed Sep. 28, 2005, the entirety of which is hereby incorporated by reference.

### BACKGROUND OF THE INVENTION

Traditional link state routing scales poorly when used in a mobile ad hoc network. This is because updates to the states of links are flooded by each node upon each link-state change, periodically, or both, to every other node in the network. Approaches to making link-state routing scale for ad hoc networks may be broadly classified into efficient dissemination approaches and limited dissemination approaches. Both attempt to reduce the routing update overhead but do so in different ways. In efficient dissemination, updates are sent throughout the network, but more efficiently compared to traditional dissemination. In contrast, limited dissemination consists of restricting the scope of routing updates in space and time.

### SUMMARY OF THE INVENTION

There is a need in the art for a more efficient dissemination of link state information in mobile ad hoc networks, which limited dissemination techniques and efficient dissemination techniques, by themselves, do not provide. Thus, in one aspect, the invention relates to a method of operating a wireless network including using a limited-efficient-dissemination process for distributing routing information, combining features from both limited dissemination and efficient dissemination processes. For example, in one embodiment, the limited-efficient-dissemination process includes limited dissemination routing features found in Fuzzy Sighted Link State protocols, such as the Hazy Sighted Link State protocol. The limited-efficient-dissemination process also includes efficient dissemination features usually included in multipoint relay protocols. The multi-point relay protocol features may include the selection of relays based on energy efficiency. In other aspects, the invention relates to routers configured to execute the above-described method and computer readable media encoding instructions for carrying out the same.

### BRIEF DESCRIPTION OF THE DRAWINGS

The system and methods may be better understood from the following illustrative description with reference to the following drawings in which:

FIG. 1 is a conceptual diagram of an ad hoc wireless network;

FIG. 2 is a conceptual block diagram of a path management module of a router within the ad hoc wireless network of FIG. 1, according to an illustrative embodiment of the invention;

FIG. 3 is a conceptual diagram of a link state update packet transmitted by the router of FIG. 2, according to an illustrative embodiment of the invention; and

FIG. 4 is a flowchart of a method of selecting a link state update mode performed by the router of FIG. 2, according to an illustrative embodiment of the invention;

FIG. 5 is a graph illustrating link state distribution distances in relation to time used by the router of FIG. 2, while operating a scoped updating mode, according to an illustrative embodiment of the invention;

FIG. 6 is a flowchart of a method of selecting relay nodes performed by the router of FIG. 2, according to an illustrative embodiment of the invention;

FIGS. 7A-C are illustrative broadcast trees illustrating various link dissemination protocols.

FIG. 8 is a flowchart of a method of handling received link state update messages performed by the router of FIG. 2, according to an illustrative embodiment of the invention.

### DESCRIPTION OF AN ILLUSTRATIVE EMBODIMENT

To provide an overall understanding of the invention, certain illustrative embodiments will now be described, including systems, methods, and software for disseminating routing information over a wireless network. However, it will be understood by one of ordinary skill in the art that the systems, methods, and software described herein may be adapted and modified as is appropriate for the application being addressed and that the systems, methods, and software described herein may be employed in other suitable applications, and that such other additions and modifications will not depart from the scope hereof.

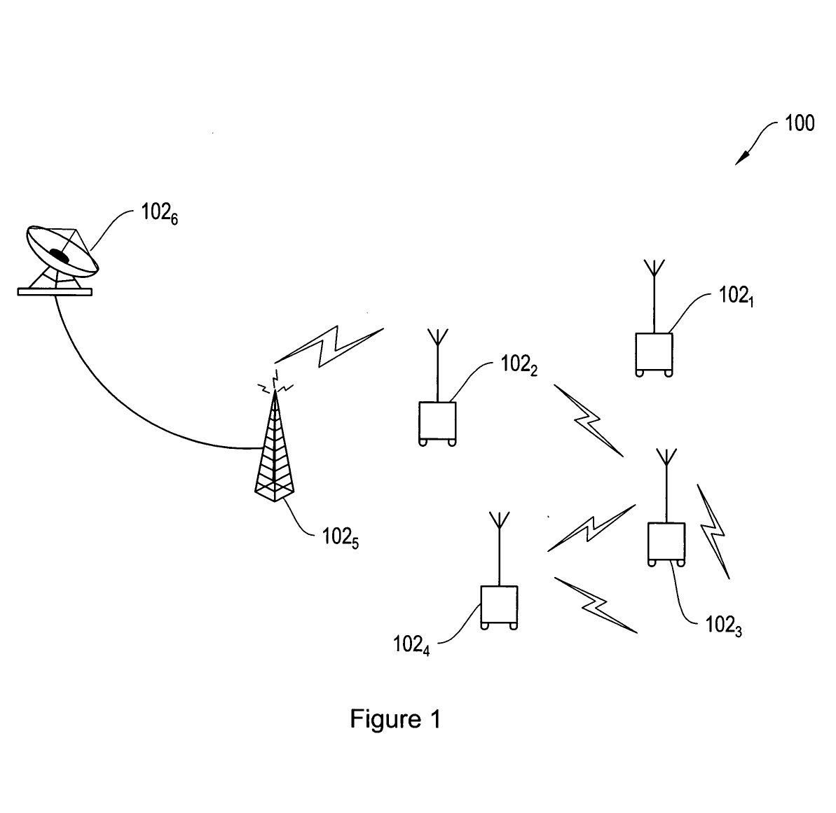

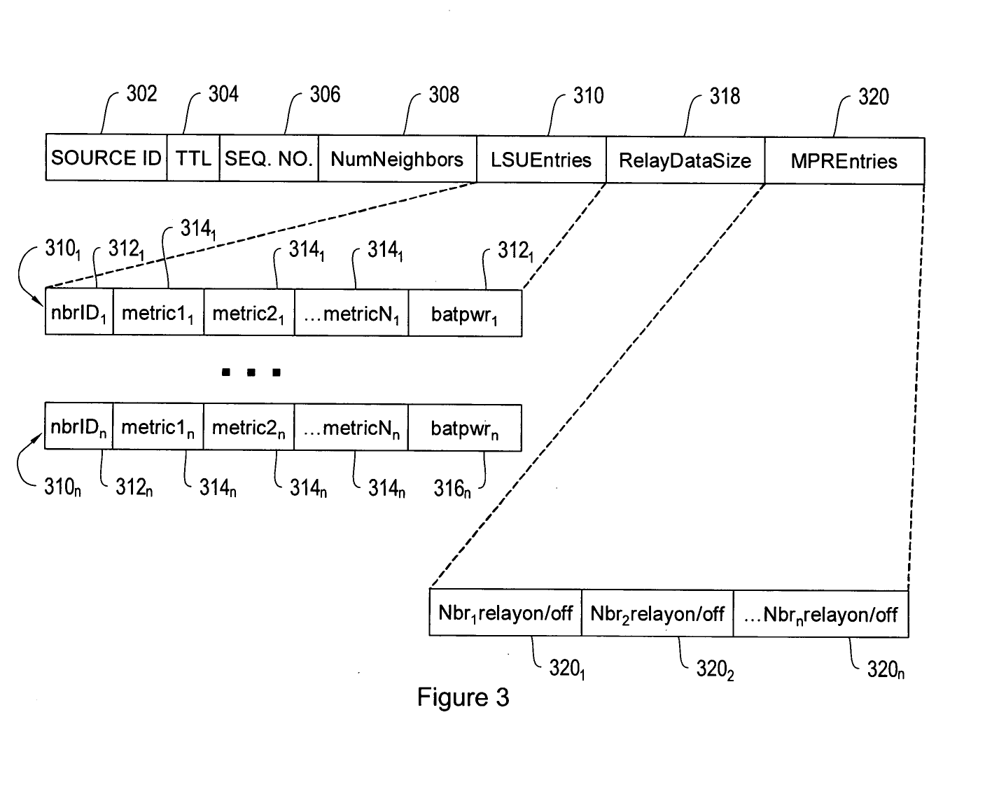

FIG. 1 is a conceptual diagram of an ad-hoc wireless network 100, according to an illustrative embodiment of the invention. The general notion of an ad hoc wireless network 100 is well known in the art. In general, an ad hoc wireless network 100 includes a plurality of wireless nodes (generally nodes 102), including routers and non-router nodes. Some number of the nodes 102 are mobile, for example, nodes 102₁-102₄, resulting in the topology of the ad hoc wireless network 100 frequently changing. Nodes 102 enter and leave the ad hoc wireless network as they move, if possible and/or efficient. Routers, such as nodes 102₂, 102₃, and 102₅ within the network maintain communication links among nodes 102, despite node movement, in part by disseminating link state update messages (“LSUs”). LSUs identify available communication links and information related to potential links among nodes 102 within the ad hoc network 100. The format of an LSU appropriate for use in the system is described further below in relation to FIG. 3. A node 102 is considered to be part of the ad hoc wireless network 100 if the node 102 is in wired communication, or is within the wireless communication range of at least one other node 102 in the network. One or more of the nodes 102 in the network may also be fixed in location and/or connected to a wired-line or other communication link to nodes outside of the ad hoc wireless network 100.

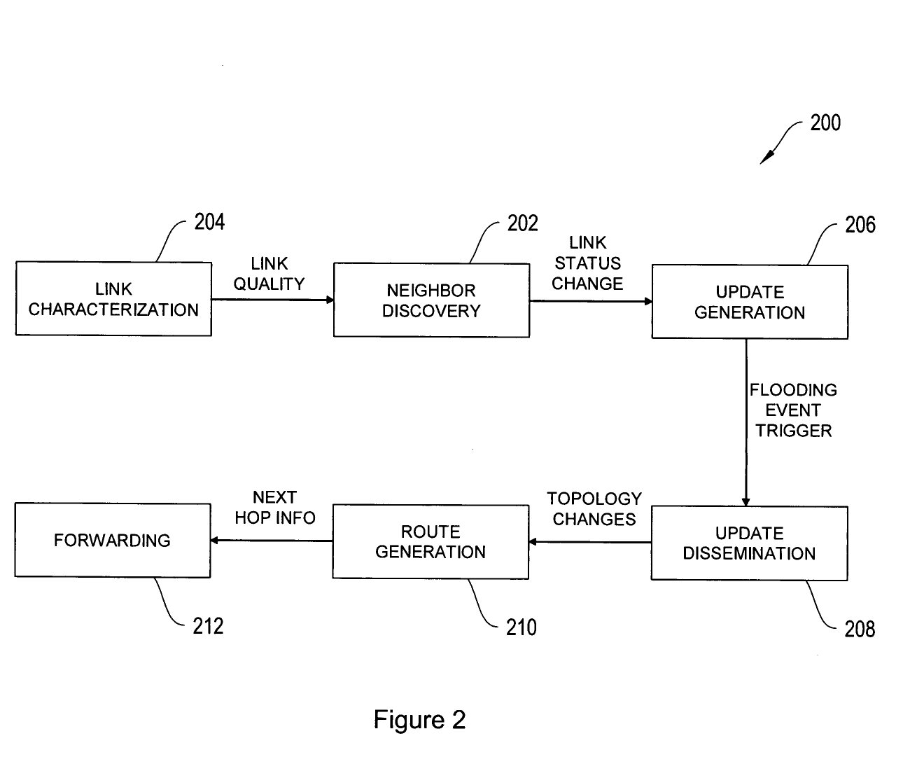

FIG. 2 is a conceptual block diagram of a path management module 200 (“PM module 200”) utilized by a router, for example node 1023, in the ad hoc wireless network of FIG. 1 to determine communication paths through the ad hoc wireless network 100, according to an illustrative embodiment of the invention. More particularly, the PM module 200 is responsible for routing and forwarding data packets from a given source to one or more destinations. As mobile nodes can often only carry a limited power supply, the PM module 200 aims to route and forward packets in an energy conserving fashion, as is further described below. In general, power usage correlates to the number of bits transmitted and received by a node and the power used by the node to transmit and receive those bits.

The PM module 200 includes a number of sub-modules for carrying out particular functions. Each sub-module may be implemented in software, for example in a higher level programming language such as C, C++, JAVA, Pascal, etc. The software can be encoded on a computer readable medium such as a magnetic, optical, or magneto-optical storage media or other form of RAM or ROM. Various features may also be implemented in hardware, such as in an application specific integrated circuit, a field programmable gate array, or other integrated circuit. The modules include a neighbor discovery module 202, a link characterization module 204, an update generation module 206, an update dissemination module 208, a route generation module 210, and a forwarding module 212.

The neighbor discovery module 202 evaluates LSUs received by the router to monitor the set of nodes with which the router can communicate with directly. That is nodes within one communication hop of the router. The neighbor discovery module 202 can detect both new nodes 102 that have entered the radio range of the router, and it can also detect the departure of a node from the radio range of the router The neighbor discovery module 202 outputs detections in changes to the set of one-hop neighbor nodes to the update generation module 206.

The link characterization module 204 analyzes qualities, referred to as routing metrics, of the links between the router and its one-hop neighbors. The link characterization module 204 outputs routing metrics update messages to the update generation module 206 indicating changes to the routing metrics. In one implementation, the link characterization module 204 monitors three routing metrics, though fewer or more metrics may employed in other implementations. For example, in other implementations, the link characterization module 204 may only take into account an energy routing metric, such as the power necessary to reliably transmit a packet over a link to a one-hop neighbor.

The PM module 200 is flexible in the number and type of metrics used. It primarily uses routing metrics whose effect on a path are additive. For an additive routing metric, the effect of the routing metric for each link in the path on the total path can be captured by adding the routing metric for the link to the cumulative path cost. Examples of additive metrics include, without limitation, energy, hop-count, interference, and delay. Some metrics which are not directly additive can be transformed to additive counterparts. For example, reliability is not a directly additive metric, since the reliability of a path is the product of the reliabilities of the links forming such path, as opposed to the sum. However, the logarithm of link reliability is an additive metric, since the logarithm of the total reliability will be equal to the sum of the logarithms of each link reliability value.

The update generation module 206 evaluates the outputs of the neighbor discovery module 202 and the link characterization module 204 to determine whether changes have occurred in the network topology that merit updating the routing tables of the router 102₃ or of other routers in the network. The updating generation module 206 can evaluate changes in each routing metric based on absolute routing metric values, absolute routing metric value changes, and/or on routing metric percentage changes.

In operation, the update generation module 206 generates a new LSU (though the LSU ultimately may not be transmitted) in response to receiving a routing metrics update from the link characterization module 204, or in response to receiving an update from the neighbor discovery module 202. The update generation module 206 also passes the LSU to the route generation module 210 to update a database storing the topology of the network. The topology database includes a history of LSUs generated and transmitted by the PM module 200.

Upon generation of a new LSU, the update generation module 206 compares the newly generated LSU to the most recent one currently stored in the topology database. The comparisons will return one of three values: no change, small change, or large change. In the case of no change, the newly created LSU is deleted. The update generation module maintains threshold change parameters for each routing metric to differentiate between small and large changes. As mentioned above, the change thresholds may be in the form of absolute values, absolute changes, or percentage changes. Changes in a routing metric that are less than the threshold are considered small changes. Changes in a routing metric equal to, or exceeding the threshold are considered large changes. In one implementation, if any of the routing metrics in the LSU have undergone any change, large or small, the generated LSU is forwarded to the update dissemination module 208 for transmission to other nodes 102. In other implementations, the LSU is only forwarded to the update dissemination module 208 in response to detecting either a large change in at least one routing metric, or small changes in at least two routing metrics.

In the alternative, or in addition, the update generation module 206 queries the neighbor discovery module 202 and the link characterization module 204 periodically to generate a requested LSU. The periodicity may be fixed, or it may vary based on network or router conditions. For example, in one implementation, an update generation module 206 in a router in a network experiencing a great deal of flux generates LSUs more often than an update generation module 206 in a network in which changes in network topology are infrequent. Similarly, the update generation module 206 generates LSUs more frequently upon router startup or upon entry of the router into a new network. The update generation module 206 compares the requested LSU with the most recently transmitted LSU. The comparison returns no change when both LSUs are the same. It returns large change when any change to any routing metric exceeds its corresponding threshold parameter, as described above. When some change occurs to a routing metric in the LSUs, but the change does not qualify as a large change, it is deemed a small change. In one implementation, if any of the routing metrics in the requested LSU have undergone any change, large or small, the requested LSU is forwarded to the update dissemination module 208 for transmission to other nodes 102 and to the route generation module 210 for updating the topology database. In other implementations, the most recently LSU is only forwarded to the update dissemination module 208 in response to detecting either a large change in at least one routing metric, or small changes in at least two routing metrics. In addition, based on the current set of metrics of all the links, the update generation module 206 updates data in the topology database that maps the link characteristics to a number of routing metrics.

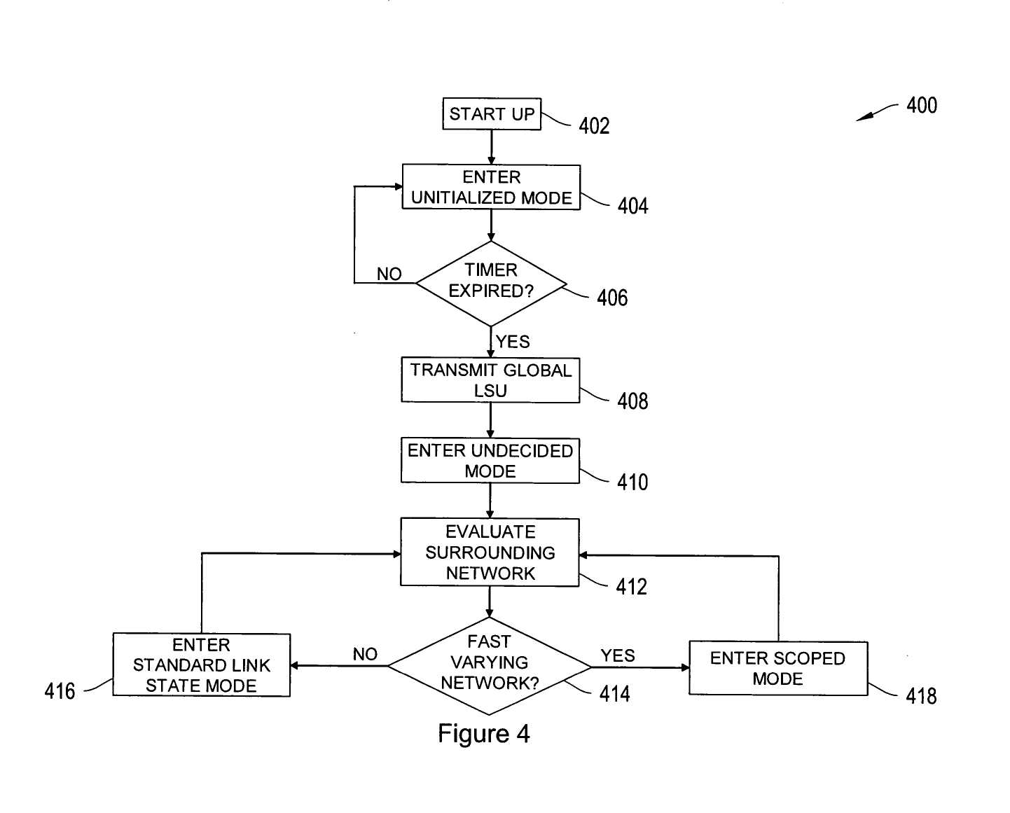

The update dissemination module 208 is responsible for disseminating to other nodes in the network LSUs generated by the update generation module 206 and received from other nodes. The update dissemination module 208 may operate in at least two modes, a standard link state dissemination mode and a energy conserving dissemination node. The update dissemination module 208 may also operate in unintialized and undecided modes. In other implementations, the update dissemination module 208 operates solely in the energy conserving mode, or in the uninitialized and energy conserving modes, only. The method used by the update dissemination module 208 for switching between modes is described below in relation to FIG. 4.

In the uninitialized mode entered, for example, upon start-up of the node, the update dissemination module does not transmit any LSUs. The MP module 200 instead waits to collect more information about the surrounding network topology. In one implementation, after a period of time of collecting information, the update dissemination module 208 broadcasts the most recent LSU in the topology database. The update dissemination module 208 transmits this first LSU transmission such that is forwarded throughout the network, and then the update dissemination module 208 enters the undecided mode. In the undecided mode, the update dissemination module 208 monitors the level of topology change in the surrounding network in order to determine whether to operate in the standard link state dissemination mode or the energy conserving energy conserving mode.

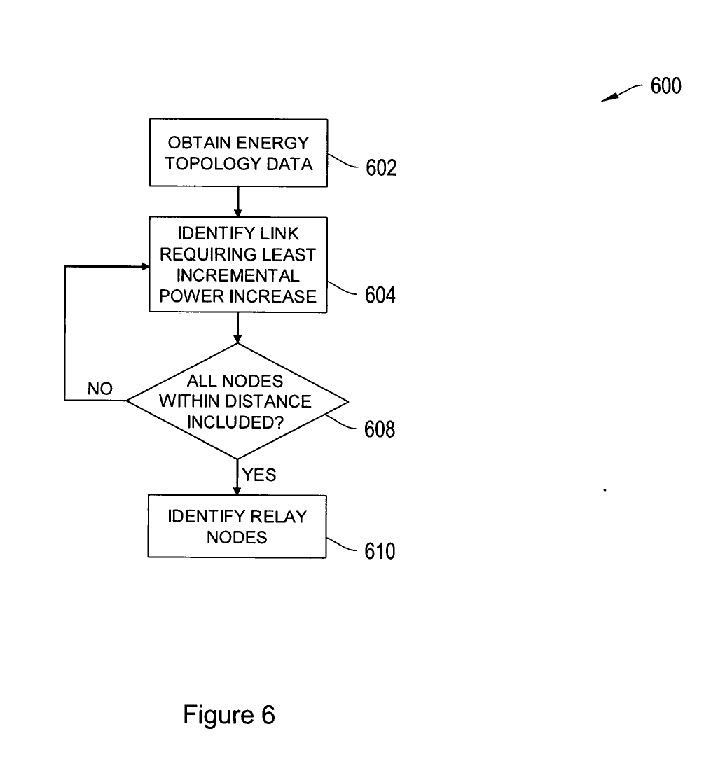

In the standard link state dissemination mode, the update dissemination module 208 transmits LSUs forwarded from the update generation 206 and LSUs received from other modules such that the transmitted LSUs are flooded substantially throughout the ad hoc wireless network. The flooding may or may not utilize a multipoint relay protocol to reduce redundant LSU transmission. If a multipoint relay protocol is used, the update dissemination module 208 only selectively forwards LSUs received from other nodes 102. In general, a multipoint relay process selects some set of nodes 102 on the network 100, such that if each of the selected nodes 102 retransmits a message, all desired recipients of the message receive the message. One suitable multipoint relay process is described below in relation to FIG. 6.

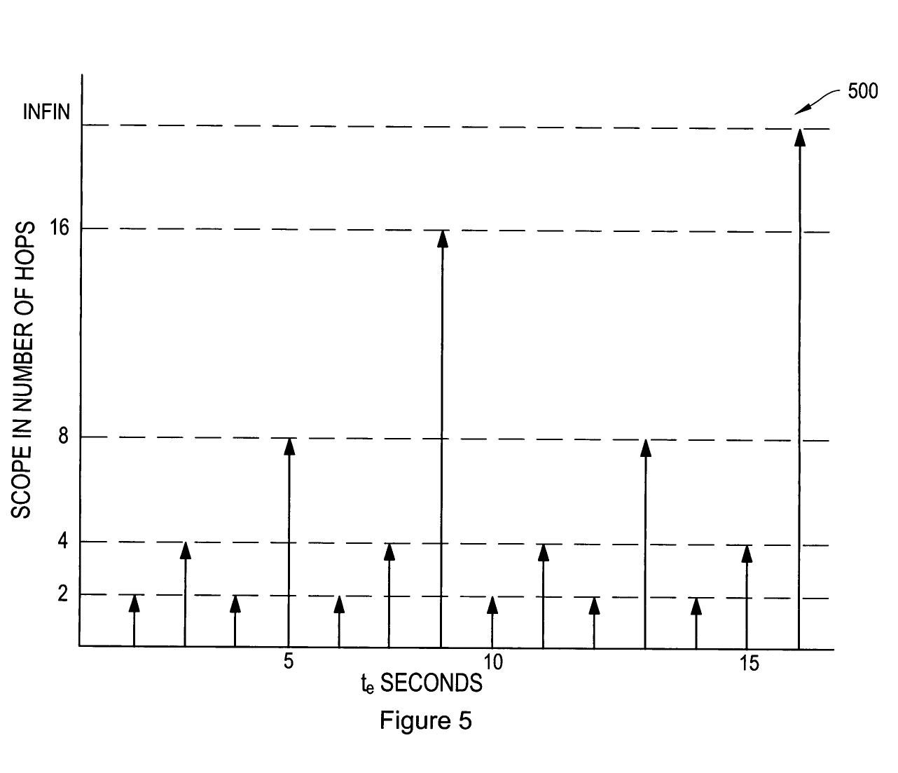

In the energy conserving dissemination mode, the update dissemination module 208 utilizes two processes, a scoping process and a multipoint relay process, such as the multipoint relay process referred to above and described in relation to FIG. 6. The scoping process, in general, limits the distance messages are transmitted, reducing the number of intended recipients of the message. The scoping process thus reduces the number of times LSUs are forwarded. The scoping process is described below in more detail in relation to FIG. 5. Each of the two processes reduces the number of other nodes in the network that retransmit a disseminated LSU. Fewer retransmissions results in less energy usage, and conservation of energy by the network in aggregate. The processes are designed to limit the detriment they might impose on routing traffic through the network.

The route generation module 210 builds and maintains a database describing the topology of the network in which node operates. The topology database includes information derived from LSUs generated by the update generation module 208 and from LSUs received from other nodes. The topology database describes the network, as the node knows it, from the perspective of that node.

The route generation module 210 then builds a set of forwarding tables based on the topology database. The route generation module 210, builds one forwarding table for each routing metric used by the node, plus one forwarding table for minimum hop routing (if not already used as a metric). The forwarding tables are indexed by a destination id and map each known destination to a next-hop node, i.e., a node within one communication hop from the router to which data packets addressed to the respective destinations are to be forwarded. The neighbors identified in the forwarding tables may vary based on a particular type of service requested in a packet. The forwarding tables may also identify a link profile to use when forwarding packets. A link profile includes information related to the physical link between the neighboring nodes, for example, the amount of power needed to reach the neighboring node, or a direction to the neighboring node.

The route generation module 210 populates the forwarding tables using Dijkstra's algorithm, variations thereof, or other routing algorithms. In conventional applications of Dijkstra's algorithm, the algorithm attempts to minimize the number hops between a source and a destination, i.e., to find the “shortest” path. The shortest path, though, is often not energy efficient. Short paths including fewer hops usually include long-range hops, which, in turn, use high transmit power. The route generation module 210, in one implementation, employs a modified version of Dijkstra's algorithm based on distribution of energy costs. To implement the energy-cost based routing algorithm, LSUs generated by the update generation module 206 include “link activation energy,” i.e., energy required to transmit messages between neighboring nodes, as a routing metric. The route generation algorithm uses the link activation energy as the cost metric. Thus, a shortest-cost metric path translates into a reduced energy route. In other implementations, in which multiple routing metrics are used, the route generation module 210 applies Dijkstra's algorithm once for each routing metric used, and once again for the fewest number of hops.

The forwarding module 212 stores the forwarding tables generated by route generation module 210, or copies thereof. Using the forwarding tables, when a packet for a given destination arrives, or when a packet is originally transmitted from the router, the forwarding module 212 looks up the next hop node on a path to the destination of the packet. The packet is then transmitted to the next-hop node.

FIG. 3 is a conceptual diagram of the format used for a LSU 300, according to an illustrative embodiment of the invention. For each of the following data fields included in a LSU 300, an illustrative number of bits is provided. The actual number of bits, however, may vary from implementation to implementation based on characteristics of the particular network the LSU 300 is transmitted through. The example LSU 300 includes a 16-bit source ID 302 indicating the node that generated and initially transmitted the LSU 300. The LSU 300 includes a 16-bit time-to-live (“ttl”) field 304 indicating the number of additional hops the source node intends the LSU 300 to be retransmitted.

A 32-bit sequence number 306 is included to aid in the identification of duplicate LSUs. Each new LSU 300 generated by the source node is assigned a sequentially increasing sequence number 306 until the maximum sequence number 306 is assigned to an LSU 300. At such time the sequence number 306 is reset.

The LSU includes an 8-bit numNeighbors value 308 indicating the number of nodes that are within one hop of the source node. For each one-hop neighbor, the LSU also includes a link state entry 310₁-310_{numNeighbors} (generally “link state entry 310”). Each link state entry 310 includes a 16-bit neighborID 312 identifying the neighboring node, as well as 8-bit values for the routing metrics 314₁-314_{N} associated with the node. If information is available related to remaining battery power 316 of a neighboring node, that information is also included in the corresponding link state entry 310 as an 8-bit value.

The LSU 300 also includes data fields identifying relay nodes selected by the source node, i.e., nodes the source node is requesting to retransmit the LSU 300. The LSU 300 includes a relay data size field 318 indicating how much relay data 319 is included in the LSU 300. For each neighbor of the node transmitting the LSU 300, the relay data 319 includes an 8-bit relay flag 320₁-320_{N}. The relay flag 320ᵢ for a neighbor i, in the illustrative implementation, takes the form of a bitwise ORing of the neighbor-id 312 and 10000000 if that neighbor is to be a relay, or just the neighbor id 312 if the neighbor is not to be a relay. For instance, if a neighbor with a neighbor id 312 of 00000010 is to be a relay, the relay flag 320 is set to 10000010. For each node the LSU 300 indicates is to serve as a relay, the LSU 300 optionally includes a list of relay IDs 322, indicating the intended recipients of a relay node's retransmission of the LSU 300.

FIG. 4 is a flow chart of a method of selecting modes of LSU dissemination 400, used by a update dissemination module 208 of a router, according to an illustrative embodiment of the invention. Upon start-up of the router (step 402), the update dissemination module 208 enters an uninitialized mode (step 404). Router start-up (step 402) may include actual powering up of the router from a powered-down state or entry of the router into network coverage from an area without network coverage. In the uninitialized mode, the router receives beacons and LSUs from neighboring nodes, but the router does not transmit LSUs to its neighbors. The router remains in the uninitialized mode for a predetermined period of time, for example, 1 to 5 minutes. Upon determining that the predetermined time period has elapsed at decision block 406, the router transmits a global LSU (step 408) including its most up-to-date link information. The global LSU is transmitted such that is forwarded substantially through the network to which the router belongs. In an alternative embodiment, the router remains in the unitialized mode, evaluating the average rate of LSU receptions (“the average LSU rate”), until the rate of change of the average LSU rate falls below a predetermined threshold.

After transmitting the global LSU (step 408), the router begins operating in the undecided mode (step 410). In this mode, the router evaluates the rate of change of neighboring network links (step 412). In evaluating the rate of change (step 412), the router analyzes the routing metric change evaluations described above. If, over a predetermined period of time, the only routing metric changes detected by the router are small changes, the router determines it is in a slow varying environment. In one implementation, the predetermined period of time is equal to R*Tₑᵥₑₙ/2 seconds, where R is the minimum power of 2 such that the network diameter is within R and 2R. If the router detect a large change in a routing metric associated with one of its neighboring nodes in the time period, the router determines it is in a fast varying environment.

If at decision block 414, the router determines it is a slow varying environment, the router enters the standard link state dissemination mode (step 416). In theory, in slow varying environments, there will be fewer LSUs needed to keep nodes ' routing tables up to date, and thus the exchange of LSUs will require less overhead and consume less power. However, in fast varying environments, LSUs are needed more frequently, and thus the number of times each LSU is retransmitted is limited to decrease overhead and power consumption. Thus, if at decision block 414 the router determines it is in a fast changing network, the router enters the energy conserving dissemination mode (step 418). After entering one mode or the other, the router begins reevaluating the rate of change of the surrounding network topology (step 412) to determine if a change in dissemination mode becomes warranted. In alternative embodiments, after transmitting the global LSU (step 408), the router skips operating in the undecided mode (step 410) and begins, substantially immediately, operating in either the standard link state dissemination mode (step 416) or operating in the energy conserving dissemination mode (step 418).

As mentioned above, the energy conserving dissemination mode includes both a scoping process and a multipoint relaying process. FIG. 5 depicts aspects of one illustrative implementation of the scoping process. In particular, FIG. 5 is chart 500 of LSU dissemination scope, according to which the update dissemination module 208 of a router to set the ttl data field 304 of transmitted LSUs 300. As indicated above in relation to FIG. 3, LSUs 300 include a ttl data field 304, governing how many times a LSU 300 is to be forwarded. In the standard link state dissemination mode, the ttl data field 304 is set to infinity, such that the LSU 300 is forwarded substantially throughout the entirety of the network. As also described in relation to FIG. 3, each LSU 300 also includes a sequence number 304, allowing deletion of duplicate LSUs 300 prior to retransmission, thus preventing unlimited dissemination of an LSU 300.

In the energy conserving dissemination mode, the initial value placed in the time-to-live field 304 varies over time such that nodes close to a source node are kept more up to date than distant nodes. The result is that the timeliness of the information is a linear function of the distance between nodes in terms of number of hops. More particularly, in one implementation, the ttl data field 304 varies according to a Fuzzy Sighted Link State (FSLS) Routing process, described, for example, in “Making Link-State Routing Scale for Ad Hoc Networks,” by Santivanez et al, published in Proc. ACM Mobihoc 2001, the entirely of which is incorporated by reference.

FSLS is a limited dissemination technique. The approach behind FSLS is to send an update every ti seconds with a network scope of rⱼ, for various values of i and j. For example, in one implementation of FSLS, i=j. In this implementation, routers transmit LSUs 300 every 1 second to a radius of 1 hop, every 2 seconds to a radius of 2 hops, etc. If i exceeds a predetermined threshold, i is set back to 0. The idea is that one node's view of a second node in the network gets increasingly “fuzzy” the further away the node is, since it receives information about the node less frequently. However, the next hop in a path of a message between the nodes is determined at each intermediate node. Thus, while the source of a message may not have current information about the neighbors of an intermediate node in the message path, the intermediate node making a next-hop routing decision does have current information about its immediate surroundings.

FSLS actually represents a family of protocols, one for each combination of (tᵢ,rⱼ) instantiations. A particular member of the family, called Hazy Sighted Scoping (HSS), described, for example, in “On the scalability of ad hoc routing protocols,” by Santivanez et al, published in Proc. IEEE Infocom 2002, the entirety of which is incorporated by reference. In using an HSS process, a router controls the dissemination scope of generated LSUs 300 such that the timeliness of the information is a linear function of the distance between nodes in terms of number of hops. The basic operation is as follows: A node transmits a LSU 300 only at multiples of tₑ seconds if appropriate. A node wakes up every 2ᵢ₋ₗ×tₑ seconds. If there has been a sufficient change in the routing metrics associated with the node's neighbors in the last 2ᵢ₋ₗ×tₑ seconds, the node sends an LSU 300 with a ttl data field 304 equal to 2ⁱ. Based on the above, the sequence of time-to-live values in consecutive periods follows the pattern (1, 2, 1, 4, 1, 2, 1, 8, 1, 2, 1, 4, 1, 2, 1, 16 . . . ), limited of course, by the network diameter. If a LSU 300 ttl field value 304 is greater than the distance from the source node to any other node in the network (which will cause the LSU 300 to reach the entire network), t is reset to 0. For example, if the node executing the HSS process computes its distance to the node farthest away to be between 17 and 32 hops, the node resets the scoping process at time 16tₑ.

FIG. 6 is a flow chart of a method for identifying multipoint relays 600 used by the update dissemination module 208 for forwarding LSUs 300 according to an illustrative embodiment of the invention. Multipoint relaying (MPR) is a well-known efficient dissemination technique, described, for example, in “Optimized Link State Routing Protocol” IETF MANET RFC 3626, Oct. 2003, edited by Clausen et al, the entirety of which is incorporated herein by reference. In an MPR-based protocol, a node N determines a set of relays from the node N's one-hop neighboring nodes, such that if the set of relays rebroadcasts a packet sent by N, each of N's two-hop neighboring nodes receive the packet. Flooded packets are only retransmitted by the set of relays, thereby reducing redundant retransmissions.

In one implementation of MPR, the relays are selected so as to minimize the overlap between the sets of relayees that each relay covers, thus further reducing the duplicate transmissions received by relayees. For node N, for example, if two one-hop neighbors, node X and node Y, of node N, are chosen as the relays for node N's transmission, then the MPR process seeks to reduce the intersection between the one hop-neighbors of node X and the one-hop neighbors of node Y that are not also one hop neighbors of N. The ideal solution to this minimization problem is given by a connected dominating set of the network graph. However, identifying this set involves global knowledge of the network and is computationally an NP-complete problem.

To circumvent these feasibility barriers, the MPR process may operate with only the network state of the node N's two-hop neighborhood and may also employ a heuristic process, based on a greedy strategy of preferentially selecting the most connected one-hop neighbors for relays. This strategy is based on the assumption that flooded packets are transmitted: (1) via omni-directional broadcast and (2) at a single power level.

To conserve additional power, the greedy heuristic can be modified to select relays based on the power required to transmit a packet to the potential relay. This approach allows a node to take advantage of technologies that can reduce the costs associated with transmitting packets, such as unicast or directional-antenna transmission or variable-power transmission. In one particular energy conserving implementation of the MPR process, a source node selects relay nodes by building a broadcast tree using minimum aggregate power, based on the Broadcast Incremental Power (“BIP”) process, as described in “On the construction of energy-efficient broadcast and multicast trees in wireless networks,” in Proc. IEEE Infocom, Tel-Aviv, Israel, 2000, by J. Wieselthier et al, which is incorporated herein by reference.

The method 600 implements the BIP process as follows. A node N determines the topology of its neighboring nodes located within two hops of the node N (step 602). The topology includes data identifying the amount of power the node N requires to transmit a packet to each one-hop neighbor node N_{OH}. For each one-hop neighbor N_{OH} of node N, the topology identifies the nodes within one hop of the node N_{OH} and the amount of power the one-hop neighboring node N_{OH} requires to communicate with those nodes.

The node then proceeds with forming a minimum spanning tree for its two-hop neighborhood based on energy conservation principles (steps 604-610) in an iterative process. In step 604, node N then identifies a link to add to its broadcast tree requiring the least amount of additional power (step 604). In the first instance, the node N will select the node requiring the least power for it to reach, node N_{LP}. At decision block 608, if the broadcast tree spans from the node N to all nodes in the two-hop neighborhood, the node selects its set of relay nodes (step 610).

Subsequent to selection of the first link on the broadcast tree to node N_{LP}, additional links may be added either from the node N, or from any other node already on the broadcast tree. As before, the links are added to minimize increases in the aggregate transmission power required to reach an unconnected node. For example, if the incremental power increase required for the node N to communicate with another node, on top of the power already utilized to reach node N_{LP} is greater than the power required by node N_{LP} to communicate with a third node in node N's two-hop neighborhood, node N adds a link on the broadcast tree between node N_{LP} and the third node. The process repeats until the node N determines at decision block 608 that all nodes in node N's two-hop neighborhood are included in its broadcast tree, after which, node N identifies a set of relay nodes to use for retransmitting LSUs (step 610). The set of relay nodes includes all nodes in the broadcast tree directly linked to node N.

Each node determines a set of relays in this manner. Thus, the relays chosen by node N determine their own set of energy conserving relays using their corresponding two-hop neighborhoods. The union of all such two-hop neighborhood broadcast trees results in an implicit energy-efficient broadcast tree for the network. As described in relation to FIG. 3, each node transmitting an LSU identifies its MPRs in the transmitted LSU so that each node receiving the LSU can determine whether or not it is a relay and act accordingly.

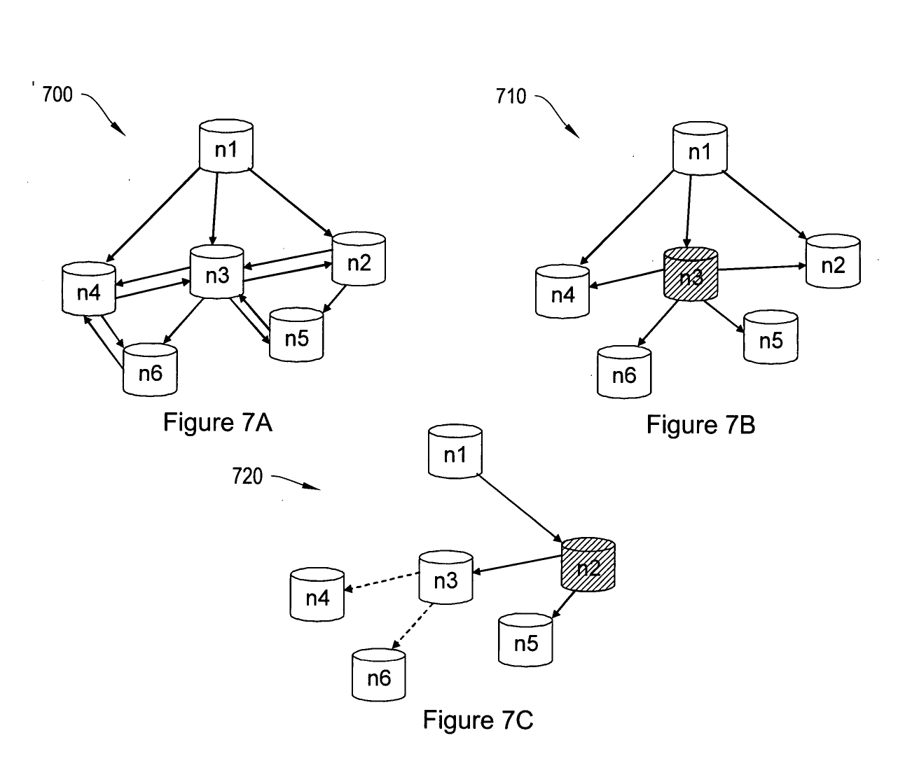

FIGS. 7A-7C illustrate the differences between networks using flooding for LSU dissemination (FIG. 7A), standard MPR for LSU dissemination (FIG. 7B), and energy-conserving MPR for LSU dissemination (FIG. 7C). FIG. 7A is a broadcast tree 700 illustrating the transmissions in a network used to distribute an LSU disseminated by node n1 using a flooding process. In the broadcast tree 700, if node n1 transmits an LSU, it is received by nodes n2-n4. Nodes n2-n4 retransmit the LSU. As a result, node n2 receives the LSU one redundant time from node n3, node n3 receives the LSU two redundant times from nodes n2 and n4, and nodes n5 and n6 each receive the LSU twice, from nodes n2 and n3 and nodes n3 and n4, respectively. Nodes n5 and n6 also rebroadcast the LSU, resulting in nodes n2-n4 receiving the LSU additional redundant times.

FIG. 7B is a broadcast tree 710 illustrating the transmissions in a network used to distribute an LSU disseminated by node n1 using a standard MPR process. In FIG. 7B node n3 is selected by node n1 as a relay as it can reach more nodes (i.e., nodes n2-n6) in one hop than any of the other one-hop neighboring nodes n2-n4. Thus, in response to node n1 transmitting a LSU, only node n3 retransmits the LSU.

FIG. 7C, is a broadcast tree 720 illustrating a broadcast tree generated by a node n1 for distributing an LSU disseminated by node n1 using the energy-conserving variation of the MPR process. In building the broadcast tree 720 according to method 600, node n1 initially selects node n2 to add to its broadcast tree. Subsequently, node n1 determines that node n2 requires less power to communicate with node n3 than node n1 would have to increase its own transmission power to communicate with n3 directly. Thus, node n1 adds a link on the broadcast tree between node n2 and node n3. After all nodes within two hops of node n1 are linked to the broadcast tree, node n1 determines a set of relays, in this case, only node n2. As indicated above, each node determines its own set of relays. Thus, the transmissions depicted in the broadcast tree may differ from actual resulting transmissions as node n2 may select different nodes as relays than node n1 would expect.

In addition to storing the forwarding tables, as described above, the forwarding module 212 also controls the forwarding of data traffic. The forwarding module 212 provides simple and extensible switching for unicast, broadcast and multicast application packets, as well as network control packets (e.g. neighbor heartbeats, routing LSUs, etc.).

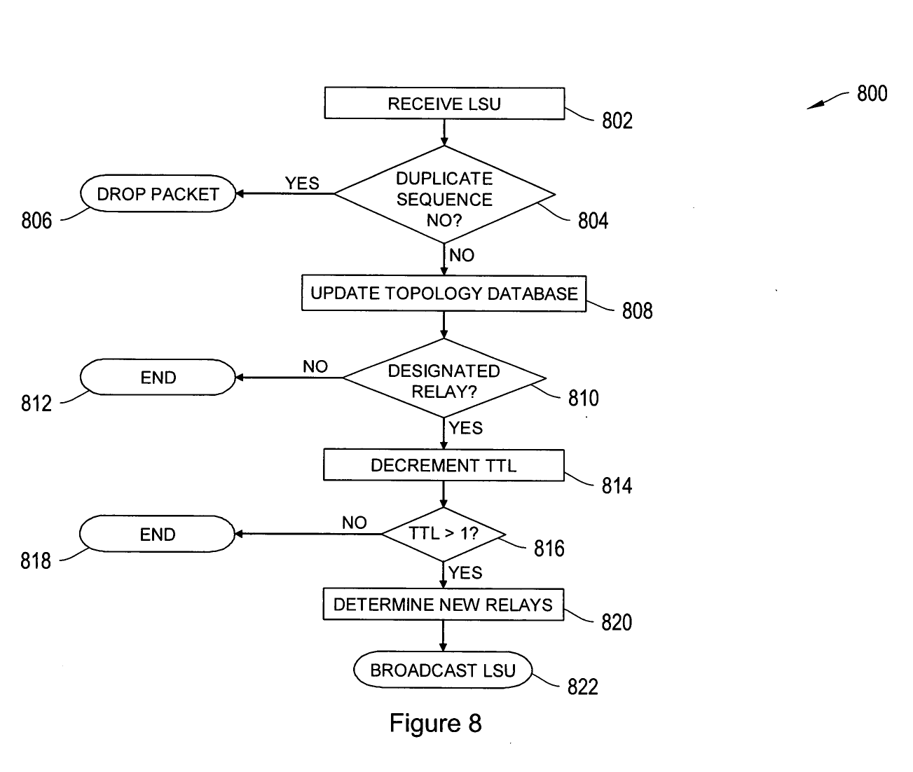

FIG. 8 is a flow chart of a method of processing a received LSU 800, the according to an illustrative embodiment of the invention. Referring to FIGS. 3 and 8, the LSU processing method 800 begins with the receipt by a receiving node of a LSU 300 (step 802). The receiving node extracts the sequence number 304 from the LSU 300 and compares it to the sequence number of the LSU associated with the current data in the topology database (decision block 804). If the sequence number is less than or equal to the sequence number in the topology database, the receiving node discards the LSU as stale (step 806). If the sequence number is greater than that of the sequence number stored in the topology database, the receiving node updates the topology database with the new LSU 300 (step 808).

In alternative implementations, the receiving node maintains a list of recently received sequence numbers 304. In such implementations, the receiving node only discards a received LSU based on its sequence number 304 if it matches a sequence number 304 in the list of recently received sequence numbers 304.

The receiving node then determines whether to retransmit the data stored in the LSU. At decision block 810, the receiving node determines whether the sender of the LSU 300 (the “sending node”) designated the receiving node as a multipoint relay by reviewing the relay tags 320 included in the LSU 300. If the LSU 300 does not designate the receiving node as a relay according to the LSU 300, the receiving node ceases processing of the LSU 300 (step 812). If the receiving node is a designated relay, the receiving node determines whether to retransmit the LSU in accordance with the scoping process employed by the sending node. The receiving node decrements the value in ttl data field 304 of the LSU 300 (step 814). At decision block 816, if the resulting value is less than one, the receiving node ceases processing of the LSU (step 818). If the resulting value in the ttl data field 304 equals or exceeds 1 at decision block 816, the receiving node determines a set of relays (step 820) based on the updated topology database, and transmits a new LSU 300 (step 822) including the original topology information of the LSU with a new set of relays and the decreased ttl value in the ttl data field 304.

For non-LSU traffic, when a packet arrives from either the IP layer (e.g., a packet generated by an application) or the radio layer (e.g., a packet received from the network) or a local control module (routing, neighbor discovery, etc.), the packet's address type is evaluated to be either unicast, or broadcast. If a packet has a unicast address, and the address matches an address of the node itself, the packet will be sent up through the IP layer to an application.

If the packet has a unicast address but is not intended for the receiving node, the forwarding module processes 212 the packet as follows. The forwarding module 212 consults the forwarding tables to determine an appropriate next-hop node and an appropriate radio profile to use. The forwarding module 212 then constructs a message that contains information including a message type identifier, a next-hop address, a pointer to a packet buffer to be sent, the length of the packet buffer (e.g., in bytes), a radio profile structure specifying transmission parameters for the packet and a length of the radio profile. The forwarding module 212 then enqueues the message for the radio layer.

The forwarding module 212 handles broadcast messages in a similar fashion, except without the next-hop lookups. The forwarding module 212 still determines an appropriate radio profile and still adheres to queuing discipline to ensure any specified service requirements are met. For example, the queuing discipline may describe a packet as an emergency broadcast or perhaps only as a periodic beacon that could be dropped, if necessary. Similarly, the radio profile could describe the broadcast as one for only a node's closest neighbors (e.g. use low power for this broadcast), or perhaps to as many nodes as can be reached at the moment (e.g. highest power). The forwarding module 212 does not peek into the radio profile. It merely passes the radio profile down to the link/radio layer of the node. Therefore, any decisions of, say, particular transmit power for reaching a particular set of neighbors must be determined by the module that created and loaded the radio profile. The parameters in the radio profile are then used by the radio to transmit the message.

The invention may be embodied in other specific forms without departing form the spirit or essential characteristics thereof. The forgoing embodiments are therefore to be considered in all respects illustrative, rather than limiting of the invention.

What is claimed is:

1. A router comprising:
a processor configured to
i) on a first periodic basis, initiate a transmission of a first routing update message for retransmission by a first node located within a first distance from the router;
ii) on a second periodic basis, initiate a transmission of a second routing update message for retransmission by at least a second node located within a greater distance from the router, wherein the second periodic basis is less frequent than the first period basis; and
iii) select a set of relay nodes to reduce the number of messages transmitted on a network on which the router resides.

2. The router of claim 1, wherein the second node includes the first node and at least one additional node located further away from the router than the first node.

3. The router of claim 1, wherein the processor includes means for determining the set of relay nodes by applying a multi-point relay process.

4. The router of claim 1, wherein the processor selects the set of relay nodes from a plurality of nodes by identifying ones of the plurality of nodes capable of forwarding messages to a remainder of the plurality of nodes with a reduced expenditure of energy.

5. The router of claim 4, wherein the set of relay nodes is selected using a broadcast incremental power process.

6. The router of claim 1, wherein the first distance is a first number of radio hops from the router and the greater distance is a larger number of radio hops from the router.

7. The router of claim 1, comprising including an indicator of the first distance in the first update message.

8. The router of claim 1, wherein the router is configured:
to receive a routing update message including a distance indicator;
in response to determining that the distance indicator is greater than a predetermined value, forwarding the received routing update message to a neighboring node; and
in response to determining that the distance indicator is less than a predetermined value, refraining from transmitting the received routing update message to the neighboring node.

9. The router of claim 8, wherein the neighboring node is in the set of relay nodes.

10. The router of claim 1, wherein the processor is configured to, on a third periodic basis having a third period length, initiating the transmission of a third routing update message to a third node located within a third distance of the router, wherein the third distance is greater than the second distance and the third periodic basis is less frequent than the second period length.

11. A method of communication in an wireless network:
employing a first routing process capable of reducing a number of nodes within a particular distance that retransmit received data packets while maintaining dissemination of the data packets to the nodes; and
employing a second routing process to reduce the distance a transmitted message is forwarded.

12. The method of claim 11, wherein the first routing process reduces the number of nodes based on the energy needed to communicate between neighboring nodes in the network.

13. The network of claim 12, wherein the first routing process employs a broadcast incremental power process.

14. The method of claim 11, wherein the first routing process employs a multi-point relay process.

15. The method of claim 11, wherein the second routing process employs a hazy sighted link state process.

16. The method of claim 11, comprising transmitting routing update messages on a periodic basis.

17. The method of claim 16, comprising initiating transmission of routing update messages to nodes within a first distance on a first periodic basis and initiating transmission of routing update messages to nodes within a greater distance, on a second periodic basis, wherein the second periodic basis is less frequent than the first periodic basis.

18. The method of claim 16, comprising indicating the distance to which a routing update message is to be forwarded by including a distance indicator in the routing update message.

19. The method of claim 18, comprising:
receiving a routing update message including a distance indicator;
in response to determining that the distance indicator is greater than a predetermined value, forwarding the received routing update message to a neighboring node; and
in response to determining that the distance indicator is less than a predetermined value, refraining from transmitting the received routing update message to the neighboring node.

20. The method of claim 19, wherein forwarding the received routing update message includes reducing the distance indicator.

21. A computer readable medium encoding instructions for carrying out a method of communication in a wireless network, the method comprising:
employing a first routing process capable of reducing a number of nodes within a particular distance that retransmit received data packets while maintaining dissemination of the data packets to the nodes; and
employing a second routing process to reduce the distance a transmitted message is forwarded.

22. The computer readable medium of claim 21, wherein the first routing process reduces the number of nodes based on the energy needed to communicate between neighboring nodes in the network.

23. The computer readable medium of claim 22, wherein the first routing process employs a broadcast incremental power process.

24. The computer readable medium of claim 21, wherein the first routing process employs a multi-point relay process.

25. The computer readable medium of claim 21, wherein the second routing process employs a hazy sighted link state process.

26. The computer readable medium of claim 21, encoding instructions for transmitting routing update messages on a periodic basis.

27. The computer readable medium of claim 26, encoding instructions for initiating transmission of routing update messages to nodes within a first distance on a first periodic basis and initiating transmission of routing update messages to nodes within a greater distance, on a second periodic basis, wherein the second periodic basis is less frequent than the first periodic basis.

28. The computer readable medium of claim 26, encoding instructions for indicating the distance to which a routing update message is to be forwarded by including a distance indicator in the routing update message.

29. The computer readable medium of claim 28, encoding instructions for:
receiving a routing update message including a distance indicator;
in response to determining that the distance indicator is greater than a predetermined value, forwarding the received routing update message to a neighboring node; and
in response to determining that the distance indicator is less than a predetermined value, refraining from transmitting the received routing update message to the neighboring node.

30. The computer readable medium of claim 29, wherein forwarding the received routing update message includes reducing the distance indicator.
